(19) United States
(12) Patent Application Publication
(10) Pub. No.: US 2026/0067909 A1
(43) Pub. Date: Mar. 5, 2026

(54) DYNAMIC SIDELINK (SL) AUTONOMOUS CHANNEL ACCESS

(71) Applicant: Apple Inc., Cupertino, CA (US)

(72) Inventors: Arnab ROY, San Diego, CA (US); Ahmed M. SOLIMAN, Munich (DE); Zhibin WU, Los Altos, CA (US); Onur SAHIN, San Diego, CA (US); Norman GORIS, Dortmund (DE); Oner ORHAN, San Jose, CA (US); Henning SANNECK, Munich (DE); Ayman F. NAGUIB, Cupertino, CA (US)

(21) Appl. No.: 18/821,898

(22) Filed: Aug. 30, 2024

(51) Int. Cl. H04W 72/40; H04L 1/00; H04W 72/25

(52) U.S. Cl. CPC H04W 72/40; H04L 1/0027; H04W 72/25

(57) ABSTRACT

Described herein are solutions for dynamic sidelink (SL) autonomous channel selection access. A user equipment (UE) can initiate a sensing window based on a prediction of transport block (TB) generation. A SL-capable UE operating in mode 2 can predict an arrival of a TB in a buffer of the UE and can initiate monitoring of the channel for a configured duration before the predicted arrival of the TB. A sensing and selection window size can be adapted based on traffic quality of service (QoS). The UE can dynamically adapt the sensing and selection windows based on a predicted priority or QoS of the future TBs. These and many other features and examples are described herein.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fifth generation (5G) or new radio (NR) technology, sixth generation (6G) technology, and so on. Such technology can include solutions for enabling user equipment (UE) and network devices, such as base stations, to communicate with one another.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example overview of one or more of the techniques described herein.

FIG. 2 is a diagram of an example network according to one or more implementations described herein.

FIG. 3 is a diagram of an example of a user equipotent (UE) capable of dynamic sidelink (SL) autonomous channel access according to one or more implementations described herein.

FIG. 4 is a diagram of an example of a process for dynamic SL autonomous channel access according to one or more implementations described herein.

FIG. 5 is a diagram of an example of need-based channel sensing according to one or more implementations described herein.

FIGS. 6-7 are diagrams of an examples of window start adaptation based on quality of service (QoS) according to one or more implementations described herein.

FIG. 8 is a diagram of an example of QoS-influenced sensing frequency band adaptation according to one or more implementations described herein.

FIG. 9 is a diagram of an example of activity sensing based on window size adaptation according to one or more implementations described herein.

FIG. 10 is a diagram of an example of selection window resource selection adaptation according to one or more implementations described herein.

FIG. 11 is a diagram of an example of channel sensing mode selection according to one or more implementations described herein.

FIG. 12 is a diagram of an example of artificial intelligence (AI)/machine learning (ML) functions according to one or more implementations described herein.

FIG. 13 is a diagram of an example of AI/ML model according to one or more implementations described herein.

FIG. 14 is a diagram of an example of components of a device according to one or more implementations described herein.

FIG. 15 is a diagram of example interfaces of baseband circuitry according to one or more implementations described herein.

FIG. 16 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 17 is a diagram of an example process for dynamic SL autonomous channel access according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Wireless communication networks can include user equipment (UE) capable of communicating with base stations and/or other network access nodes. The base stations can provide A UE with access to a core network (CN) and additional external networks, such as the Internet. Wireless communication networks can implement various techniques and standards that enable wireless communications to be reliable, efficient, and commensurate with any number of services being accessed.

Sidelink (SL) can be a type of device-to-device (D2D) communication (as opposed to the traditional downlink (DL) and uplink (UL) communications) is designed to facilitate direct communication between devices independent of connectivity via the cellular infrastructure. SL can have multiple applications and use cases, including enabling automotive communication (e.g., via cellular vehicle-to-everything (C-V2X)), enhancing network coverage, and providing connectivity to devices, when unlicensed band operations are unfeasible. Two resource selection modes or mechanisms can be enabled for new radio (NR) SL. Mode 1 can include time and frequency resources for SL transmission being scheduled by a base station. This of course can be limited to in-coverage UEs and when scheduling delays are tolerable. Mode 2 can include UEs autonomously selecting SL resources from a pool of resources. In this mode, UEs can operate without network coverage.

A UE before transmission can sense a channel within a sensing window for ongoing transmissions. By reading 1st-stage SL control information (SCI) of other transmissions, the UE can determine the schedules of future transmissions. The UE can also measure the reference signal received power (RSRP) of the ongoing transmissions to determine available transmission resources. Based on the sensing, the UE can first eliminate the resources from the selection window on which the UE has determined a future scheduled transmissions. From the remaining resources in the selection window, the UE can randomly select resources for use.

A meaningful category of augmented reality (AR) and virtual reality (VR) devices (e.g., head mounted devices, glasses, and other wearable devices) include devices with wireless tethering, where some of the processing (e.g., rendering) is performed in a companion device (e.g., smartphone, customer premise equipment, etc.). Wireless connectivity between the AR/VR (or XR) device and the companion device can be provided by cellular SL. In SL, significant data transfer capabilities can be involved between the XR device and the companion device, which can be independent from periodic media streaming requirements. Additionally, a V2X capable vehicle can be configured to communicate emergency information or triggered operational information to either other V2X capable vehicles or roadside units (RSUs) due to changes in its environment (e.g., vehicle turning, change in blockage situation, etc.).

In mode 2, SL resource configuration and resource selection by the UE can have several problems or challenges. Currently, without advance knowledge of incoming transport blocks (TBs), a UE can be expected to continuously monitor physical SL control channel (PSCCH_transmissions (e.g., 1st-stage SCI) to reduce transmission latency, which can be due to the sensing window occurring in the past relative to when the TB is generated. This can be constraining for battery-powered devices and does not address current usage characteristics, result in inefficient resource utilization.

The techniques described herein can include one or more solutions for the above-described deficiencies and challenges. For example, initiation of a sensing window can be based on a prediction of TB generation. A SL-capable UE operating in mode 2 can predict an arrival of a TB in a buffer of the UE and can initiate monitoring of the channel for a configured duration before the predicted arrival of the TB. In another example, a sensing and selection window size can be adapted based on traffic quality of service (QoS). The UE can dynamically adapt the sensing and selection windows based on a predicted priority or QoS of the future TBs.

In yet another example, a sensing and selection window size can be adapted based on observed channel utilization. The UE can dynamically adjust the sensing and selection window size depending on the observed channel utilization by other SL-capable UEs operating in mode 2. In a further example, resource selection during a selection window can be adapted. The UE can apply a non-uniform resource selection algorithm within the selection window to accommodate different traffic priorities or QoS, and channel occupancies. In yet another example, a relaxation mode can be implemented. The UE can use an AI/ML model to predict the idle periods (e.g., the periods in which continuous channel sensing could be stopped). In a further example, a channel sensing mode can be selected. For instance, the UE can switch between continuous and discontinuous sensing based on various factors including power status.

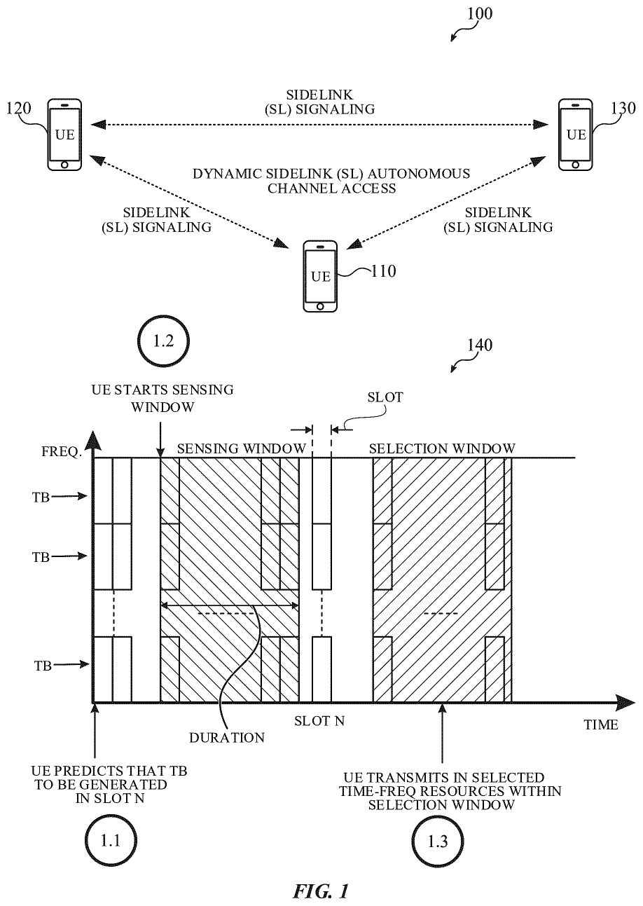

FIG. 1 is a diagram of an example overview 100 of one or more of the implementations described herein. As shown, overview 100 can include UE 110, UE 120, and UE 130, each of which can be capable of SL communications. One or more of UE 110, UE 120, and UE 130 can be capable of dynamic SL autonomous channel access. For example, referring to depiction 140, UE 110 can be configured to operate in mode 2 SL. UE 110 can determine or otherwise predict that a transport block (TB) is to be generated in a given slot N (at 1.1). UE 120 can determine a sensing window and/or start monitoring a channel during the sensing window starting at a slot preceding slot N (at 1.2). UE 120 can select and use time-frequency resources in a selection window for communicating via SL (at 1.3). UE 110 can dynamically adapt the sensing and selection windows based on a priority or QoS associated with the TB. UE 110 can adjust the size of the sensing and selection windows based on an observed channel utilization by other mode 2 SL-capable UEs. UE 110 can apply a non-uniform resource selection algorithm within the selection window to accommodate different traffic priorities, a QoS, or a channel occupancy. UE 110 can use artificial intelligence (AI)/machine learning (ML) models to determine idle periods (e.g., periods during which continuous monitoring can be periodically paused). UE 110 can switch between continuous and discontinuous sensing based on one or more triggers, factors, or conditions, such as a current power supply of UE 120. Additional examples of these and many other techniques, features, and implementations are described below with reference to the figures that follow.

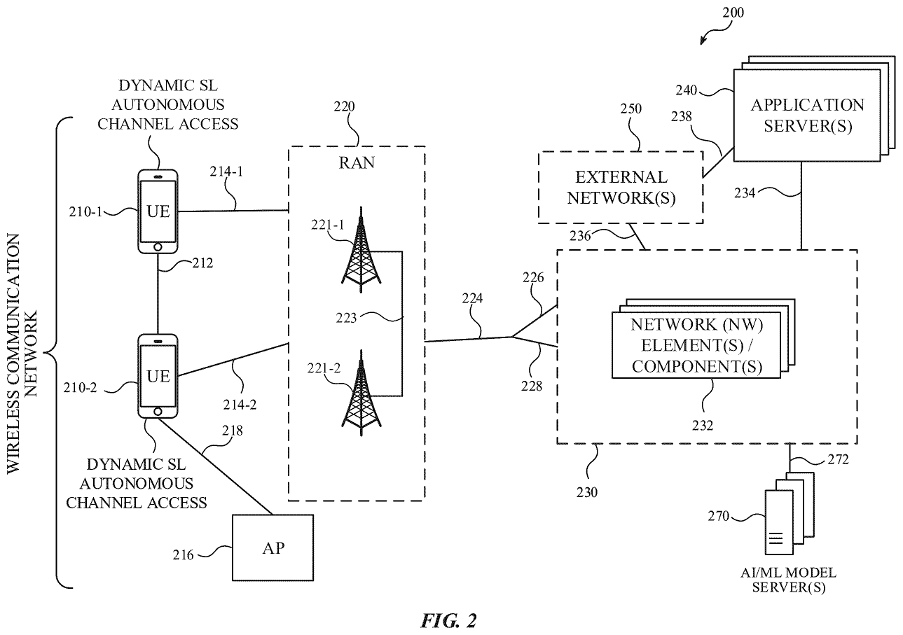

FIG. 2 is an example network 200 according to one or more implementations described herein. Example network 200 can include UEs 210-1, 210-2, etc. (referred to collectively as “UEs 210” and individually as “UE 210”), a radio access network (RAN) 220, a core network (CN) 230, application servers 240, and external networks 250.

The systems and devices of example network 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network. UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

UEs 210 can use one or more wireless channels 212 to communicate with one another. As described herein, UE 210 can communicate with RAN node 222 to request SL resources. RAN node 222 can respond to the request by providing UE 210 with a dynamic grant (DG) or configured grant (CG) regarding SL resources. A DG can involve a grant based on a grant request from UE 210. A CG can involve a resource grant without a grant request and can be based on a type of service being provided (e.g., services that have strict timing or latency requirements). UE 210 can perform a clear channel assessment (CCA) procedure based on the DG or CG, select SL resources based on the CCA procedure and the DG or CG; and communicate with another UE 210 based on the SL resources. The UE 210 can communicate with RAN node 222 using a licensed frequency band and communicate with the other UE 210 using an unlicensed frequency band.

UEs 210 can communicate and establish a connection with (e.g., be communicatively coupled) with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different RAN network nodes (e.g., RAN network nodes 222-1 and 222-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network RAN network nodes.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection 216 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230. In some scenarios, UE 210, RAN 220, and AP 216 can be configured to utilize LTE-WLAN aggregation (LWA) techniques or LTE WLAN radio level integration with IPsec tunnel (LWIP) techniques. LWA can involve UE 210 in RRC_CONNECTED being configured by RAN 220 to utilize radio resources of LTE and WLAN. LWIP can involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling can include encapsulating the entirety of original IP packets and adding a new packet header, thereby protecting the original header of the IP packets.

Described herein are solutions for dynamic SL autonomous channel selection access. UE 210 can initiate a sensing window based on a prediction of TB generation. A SL-capable UE 210 operating in mode 2 can predict an arrival of a TB in a buffer of UE 210 and can initiate monitoring of the channel for a configured duration before the predicted arrival of the TB. A sensing and selection window size can be adapted based on traffic QoS. UE 210 can dynamically adapt the sensing and selection windows based on a predicted priority or QoS of the future TBs. These and many other features and examples are described herein.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 can include network access points configured to provide radio baseband functions for data and/or voice connectivity between users and the network based on one or more of the communication technologies described herein (e.g., 2G, 3G, 4G, 5G, WiFi®, etc.). As examples therefore, a RAN node can be an E-UTRAN Node B (e.g., an enhanced Node B, cNodeB, cNB, 4G base station, etc.), a next generation base station (e.g., a 5G base station, NR base station, next generation cNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block can comprise a collection of resource elements (REs); in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 can operate using stand-alone unlicensed operation, licensed assisted access (LAA), cLAA, and/or feLAA mechanisms. In these implementations, UEs 210 and the RAN nodes 222 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information fed back from any of UEs 210. The downlink resource assignment information can be sent on the PDCCH used for (e.g., assigned to) each of UEs 210.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface can include an X2 user plane interface (X2-U) and an X2 control plane interface (X2-C).

The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. RAN 220 communicate with CN 230 via interfaces 224, 226, and/or 228. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN, and/or one or more additional or alternative types of CNs. The components of the CN 230 can be implemented in one physical node, or separate physical nodes including components to read and execute instructions from a machine-readable or computer-readable medium (e.g., a non-transitory machine-readable storage medium).

In some implementations, network function virtualization (NFV) can be utilized to virtualize any or all the above-described network node roles or functions via executable instructions stored in one or more computer-readable storage mediums (described in further detail below). A logical instantiation of the CN 230 can be referred to as a network slice, and a logical instantiation of a portion of the CN 230 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 can also, or alternatively, be configured to support one or more communication services (e.g., voice over IP (VOIP) sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

Artificial intelligence (AI)/machine learning (ML) model servers 270 can include on or more server or server device capable of receiving, processing, storing, and communicating information. AI/ML model servers 270 can communicate with CN 230 via interface 272. AI/ML model servers 270 can be implemented as a cloud of server devices, one or more virtual devices, or a combination thereof. AI/ML model servers 270 can provide one or more types of AI/ML model services. Examples of such services can creating virtual wireless environments and testing wireless devices, including components, configurations, software, and conditions relative to wireless devices, within the wireless environments. AI/ML model servers 270 can receive, generate, train, retrain, update, modify, store, test, and/or distribute one or more types of AI/ML models. Additionally, AI/ML model servers 270 can test, monitor, measure, and evaluate performance of AI/ML models in such environments. In some implementations, AI/ML model servers 270 can instead be implemented as one or more application servers or one or more other types of server devices. In some implementations, functionality described herein as being provided by AI/ML model servers 270 can be provided by another device (e.g., one or more functions of CN 230) or by a combination of combination another device and AI/ML model.

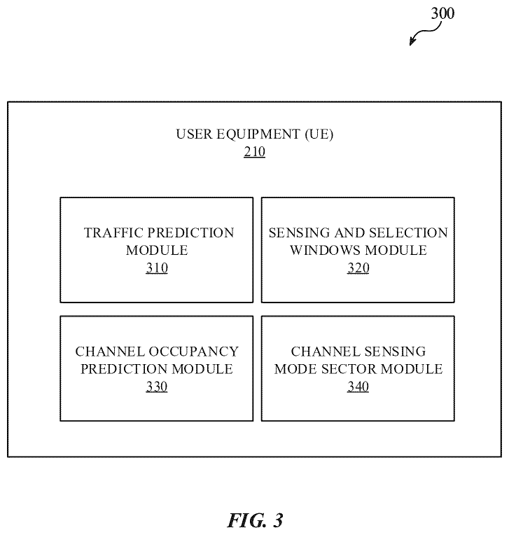

FIG. 3 is a diagram of an example 300 of a UE 210 capable of dynamic SL autonomous channel access according to one or more implementations described herein. As shown, UE 210 can include traffic prediction module 310, sensing and selection windows module 320, channel occupancy prediction module 330, and channel sensing mode selector module 340. Each module can include a combination of hardware (e.g., a physical storage device coupled to one or more processors) and software components configured to perform one or more operations or functions described herein. The hardware components can include, for example, a memory device coupled with processing circuitry. The software can include machine-readable instructions and information that can be stored by a memory device and executed by one or more processors or processing circuitry. The number, arrangement, and allocation of modules and module functions can vary depending on a given implementation. In some implementations, UE 210 can include fewer, additional, and/or alternatively modules than those shown in FIG. 3.

Modules 310-340 can operate to perform dynamic SL autonomous channel access. Each module can receive or generate one or more types of input data; perform one or more operations or functions based on the input data; and produce one or more types of output data. Examples of the input data can vary between modules, and can include a UE orientation or pose, UE heading information, packet arrival time history, in-band SL positioning measurements, out-of-band sensor inputs, and more. Examples of the output data can vary between modules, and can include next packet arrival time, confidence level, packet or TB size, QoS or priority of a next arriving packet, and more. One or more of modules 310-340 can operate based on one or more additional or alternatively factors, conditions, or triggers, such as a network configuration regarding a sensing window start time, selection window start and end times, processing time, prediction model information, and more.

Traffic prediction module 310 can be configured to predict or otherwise determine UE traffic (e.g., a TB, slot, etc.), an arrival time of UE traffic, a confidence level corresponding thereto, and more. Sensing and selection windows module 330 can be configured to predict or otherwise determine a sensing window and/or a selection window. Sensing and selection windows module 320 can also, or alternatively, be configured to adjust the size of a sensing window and/or selection window. Channel occupancy prediction module 330 can be configured to predict or otherwise determine a channel occupancy level (e.g., a high level, low level, or multiple levels) and/or a corresponding level of confidence in the prediction. Channel sensing mode selector module 340 can be configured to cause UE 210 to transition between modes of operations, such as continuous channel sensing, continuous channel sensing with idle periods, need-based channel sensing, and more. In some implementations, channel sensing mode selector module 340 (or another module of UE 210) can be configured to build, train, and deploy one or more AI/ML models to facilitate or enable one or more predictions, such as predicted idle periods. These and many other features and examples of the functionality of modules 310-340 are described herein.

One or more of modules 310-340 can be configured to use AI/ML tools for determining and/or predicting information, events, resources, or other features described herein. In some implementations, traffic prediction module 310 can use AI/ML models for traffic prediction, sensing and selection windows module 320 can use AI/ML models for determining or predicting a sensing window, determining or predicting a selection window, determining a slot between a sensing window and a selection window, etc. Channel occupancy prediction module 330 and/or channel sensing mode selector module 340 can also use AI/ML models for prediction or determination purposes. The AI/ML models can be trained based on relevant historic data. Input data and/or output data from the AI/ML models can be evaluated to validate the use of the AI/ML models, and when input data or output data is determined to be an outlier, non-conforming, or otherwise anomalous the corresponding module can fallback to a legacy or other type of non-AI/ML procedure for making a determination or prediction. AI/ML models can be created and trained by UE 210 and/or another device, such as AI/ML servers 270. UE 210 can receive AI/ML models from AI/ML servers 270 and deploy the AI/ML models locally. UE 210 can also, or alternatively, deactivate AI/ML models determined not to be producing inference outputs within tolerance parameters or conditions. In such scenarios, UE 210 can determine, select, and deploy a different AI/ML model that is more suitable for current operating conditions of UE 210.

UE 210 can also provide AI/ML models servers 270 with additional training data based on scenarios win which AI/ML models functioned properly or improperly (e.g., produced an inference output with at least a minimum threshold of accuracy). UE 210 can also, or alternatively, report to AI/ML models servers 270 a performance status or performance data of an AI/ML model (e.g., when the AI/ML model is operating properly or improperly). AI/ML models servers 270 can use performance information to update, train, and/or retrain AI/ML models. Accordingly, UE 210 and AI/ML servers 270 can cooperate with one another to generate, train, deploy, evaluate, validate, and update AI/ML modules used by one or more of modules 310-340.

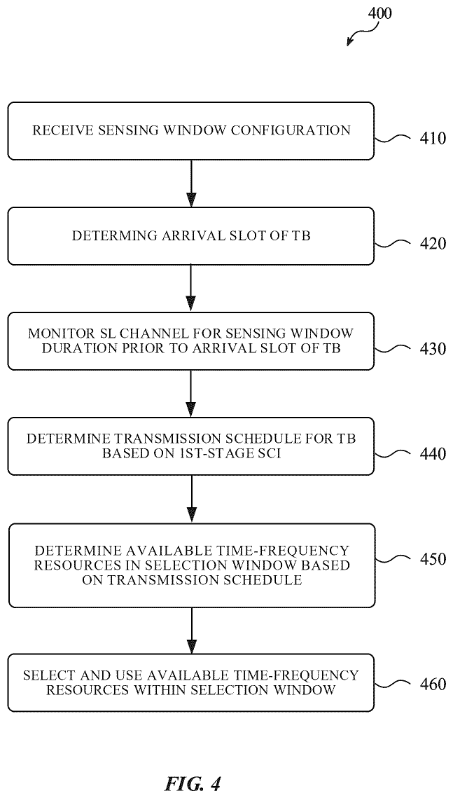

FIG. 4 is a diagram of an example of a process 400 for dynamic SL autonomous channel access according to one or more implementations described herein. As shown, process 500 can be implemented by UE 210 and/or baseband circuitry. In some implementations, some or all of process 400 can be performed by one or more other systems or devices, including one or more of the devices of FIG. 2. For example, process 400 can be implemented by UE 210. Additionally, process 400 can include one or more fewer, additional, differently ordered and/or arranged operations than those shown in FIG. 4. In some implementations, some or all of the operations of process 400 can be performed independently, successively, simultaneously, etc., of one or more of the other operations of process 400. As such, the techniques described herein are not limited to a number, sequence, arrangement, timing, etc., of the operations or processes depicted in FIG. 4. Process 400 can include a generalized example that can be implemented in one or more ways, according to more specific examples described further below with reference to the Figures that follow.

As shown, process 400 can include receiving a sensing window configuration (block 410). For example, UE 210 can receive a sensing window configuration from RAN node 222 (e.g., a base station). In some implementations, UE 210 can also, or alternatively, receive a sensing window configuration from another UE 210 via SL communications. A sensing window configuration can include time domain information and/or frequency domain information relating to a sensing window for SL communications. The sensing window can include a start time, an end time, a duration, a slot, frame, symbol, etc., for UE 210 to monitor for SL communications. The sensing window can include frequency information pertaining to the sensing window, such as range of frequencies, a type of frequency, a band, sub-band, bandwidth part (BWP), channel, sub-channel, physical resource blocks (PRBs), etc. The frequency resources of the sensing window configuration can include a licensed spectrum, unlicensed spectrum, and/or a combination thereof.

Process 400 can include determining an arrival time of a slot of a TB (block 420). For example, UE 210 can determine or predict the time domain and frequency domain resources associated with a TB scheduled to arrive at UE 210, at a buffer or memory of UE 210, etc. The prediction can be directed toward the slot of the TB. The prediction can also be directed toward a channel, sub-channel, or other type of frequency domain resource. The TB and/or slot can be outside (or beyond) a sensing window. The TB and/or slot can be outside (or before) a selection window. For example, the slot of the TB can be between an end of a sensing window and before a selection window.

Process 400 can include monitoring an SL channel for a sensing window duration prior to arrival of the slot of the TB (block 430). For example, UE 210 can monitor a sensing window for a duration prior to the arrival of the slot of the TB. UE 210 can determine a beginning slot, a sensing window duration, and an ending slot for the sensing window based on the sensing window configuration. In some implementations, UE 210 the sensing window configuration information can indicate the sensing window characteristics explicitly. In other implementations, the sensing window configuration information can indicate the sensing window characteristics implicitly, such that UE 210 can determine or derive the actual the sensing window characteristics based on the sensing window configuration information received.

Process 400 can include determining a transmission schedule for a TB based on 1st-stage SCI (block 440). For example, UE 210 can determine a transmission schedule for a TB based on a 1st-stage (or first stage) SCI. SCI Format 0-1 can be sent via a physical SL control channel (PSCCH) and SCI Format 0-2 can be sent via a physical SL shared channel (PSSCH). SCI carried on a PSCCH can be a 1st-stage SCI (e.g., SCI Format 0-1), which can transport SL scheduling information of PSSCH and 2nd-stage-SCI on PSSCH. The SL scheduling information can include priority, time/frequency resource assignment, 2nd-stage SCI format, modulation and coding scheme (MCS), and resource reservation period. The SCI carried on PSSCH is a 2nd-stage SCI (e.g., SCI Format 0-2), which transports information used for the decoding of PSSCH. This can include the HARQ process ID, new data indicator (NDI), redundancy version, source ID, and destination ID. 1st-stage SCI can indicate a reservation of N_{max_reserve} (pre-configured) number of SL resources within a resource selection window. The resource reservation can be indicated in a time resource assignment field of the 1st-stage SCI. This means that not all the slots in a resource reservation period of UE 210 can carry 1st-stage SCI in the PSCCH; some slots can be an empty PSCCH and can carry information in the PSSCH, as indicated by a 1st-stage SCI in a previous slot.

Process 400 can include determining available time-frequency resources in a selection window based on the transmission schedule (block 450). For example, UE 210 can determine available time-frequency resources in a selection window based on a transmission schedule. UE 210 can determine available time-frequency resources based on the monitoring of the sensing window, 1st-stage SCI, the TB, the slot of the TB, and one or more other types of factors, conditions, or information.

Process 400 can include selecting and using available time-frequency resources within the selection window (block 460). For example, UE 210 can select available time-frequency resources in a selection window following a sensing window. UE 210 can select the available time-frequency resources based on the monitoring of the sensing window, 1st-stage SCI, the TB, the slot of the TB, and one or more other types of factors, conditions, or information. UE 210 can use the selected time-frequency resources to transmit SL data. These and many other features and examples of the functionality of modules 310-340 are described herein.

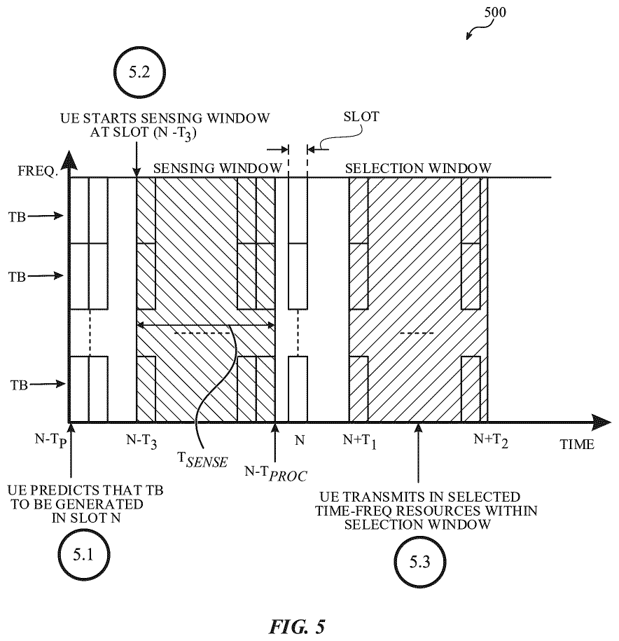

FIG. 5 is a diagram of an example 500 of need-based channel sensing according to one or more implementations described herein. As shown, example 500 include a time domain along a horizonal axis and a frequency domain along a vertical axis. The time domain can be organized according to slots. The frequency domain can be organized according to transport blocks (TBs). Example 600 can include a sensing window with a duration to Tₛₑₙₛₑ and a selection window following the sensing window. The selection window includes a slot for high priority traffic positioned early in the selection window.

Generally, UE 210 can be configured to predict that a TB is to be generated in a given slot N (at 5.1). UE 210 can determine a sensing window and/or start monitoring the sensing window at a slot preceding slot N (e.g., at slot N−T₃) (at 5.2). UE 210 can select and use time-frequency resources in a selection window for communicating via SL (at 5.3).

More particularly, UE 210 can be configured with a sensing window duration Tₛₑₙₛₑ. UE 210 predicts at time (n−Tₚ) that a TB is to be generated at slot n, where Tₚ>=Tₛₑₙₛₑ. UE 210 can start monitoring the channel at time (n−T₃), where T₃=Tₛₑₙₛₑ+T_{proc}, and T_{proc}, can be the processing time before slot N. UE can decode any 1st-stage SCI and determine the transmission schedule for the associated TB. After identifying the potentially occupied time-frequency resources in the selection window based on decoded transmission schedules, UE 210 can identify resources for a transmission randomly from the remaining available resources. When the predicted time of arrival of the TB can be split across more than one slot, with varying prediction confidence levels, then an earliest candidate slot can be considered as slot n for the purposes of determining the start of the sensing window. The resource reservation for possible re-transmission of a TB can occur as per current mechanisms, namely, either multiple resource requests in a single 1st-stage SCI (for initial transmission and re-transmission(s)), or multiple 1st-stage SCIs.

A UE traffic prediction module can take one or more of the following inputs: UE orientation or pose; UE heading information; packet arrival time history; in-band SL positioning measurements; out-of-band sensor inputs such as ultra-wideband wireless technology (UWB), radar, lidar, cameras, accelerometer, gyroscope, etc. UE traffic prediction module output can include next packet arrival time, confidence level, etc. A network configuration can include: a sensing window start time (T₃); selection window start and end times (T₁, T₂). Processing time (T_{proc}) can depend on UE category or UE capabilities reported by UE 210. Prediction model info can include model indenter (ID), parameters, etc.), prediction triggering conditions, etc.

SCI can be modified to include a predicted transmission. UE 210 can reserve resources in advance of the TB arriving in a local buffer and include the reservation in the 1st-stage SCI. A resource reservation for predicted traffic can be distinguished from that for currently pending TBs, for example by using a flag or an indication. UE 210 can include a QoS or priority for the predicted transmission in the 1st-stage SCI. UE 210 can include the prediction confidence for the predicted transmission in the 1st-stage SCI.

Another UE 210 can receive the 1st-stage SCI containing resource reservation for a predicted transmission, the other UE 210 and can override the reservation when one or more conditions is fulfilled. On example of such conditions can include the other UE 210 can have a pending TB in a local buffer belonging to a higher QoS. Another example of such conditions can include the other UE 210 can have a pending TB in a local buffer belonging to the same QoS and the prediction confidence contained in the previously received 1st-stage SCI is less than a threshold R₁. Yet another example of such conditions can include the other UE having a pending TB in a local buffer belonging to a lower QoS, and the prediction confidence contained in the previously received 1st-stage SCI is less than a threshold R₂. In some implementations, there may be multiple prediction confidence thresholds for different QoSs. For example, when the QoS level of the predicted TB contained in the previously received 1st-stage SCI is one level below the QoS level of the pending TB at UE 210, then UE 210 can use a threshold R′₂, whereas when the QoS levels differ by two levels then UE 210 can use a threshold R″₂.

In another approach, channel monitoring for reception can involve the following. An SL-capable UE can be configured by the network with parameters for performing channel sensing to monitor for incoming transmissions by other SL-capable UEs 210. The configuration can include a start time, duration, and periodicity of channel sensing duration. In such a scenario, UE 210 can monitor a PSCCH during the configured channel sensing duration for 1st-stage SCIs from other UEs 210 configured to transmit data to UE 210. After an SL data transfer session is established with a peer UE 210, the receiving UE 210 can modify a channel sensing configuration based on one or more of the following information provided by the peer (e.g., transmitting) UE 210: data transmission (e.g., periodicity, periodicity+jitter, etc.); prediction model parameters used by the transmitting UE 210 to determine future TB arrivals; and prediction model identifier (ID) used by the transmitting UE 210. When a SL data transfer session is established with a peer UE 210, a receiving UE 210 can be configured to modify a channel sensing configuration based on one or more of the following information provided by the peer UE 210: data transmission periodicity, data transmission periodicity and jitter, prediction model parameters used by a transmitting UE to determine future TB arrivals, or prediction model identifier (ID) configured to for the transmitting UE.

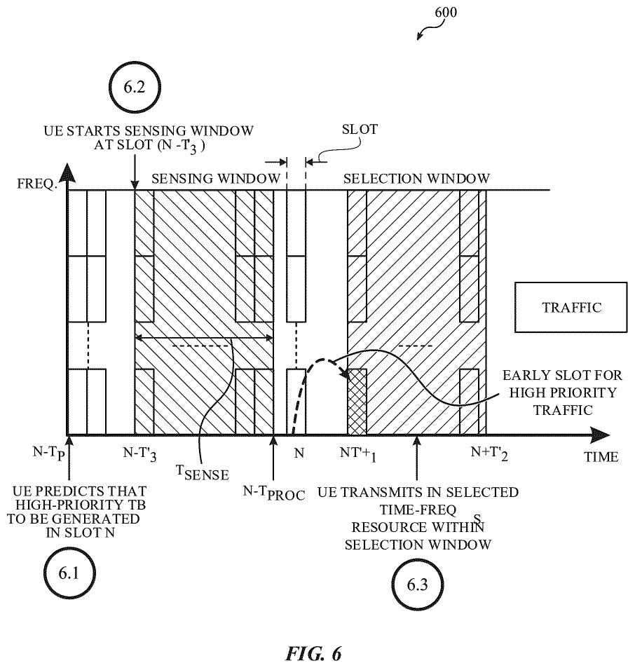

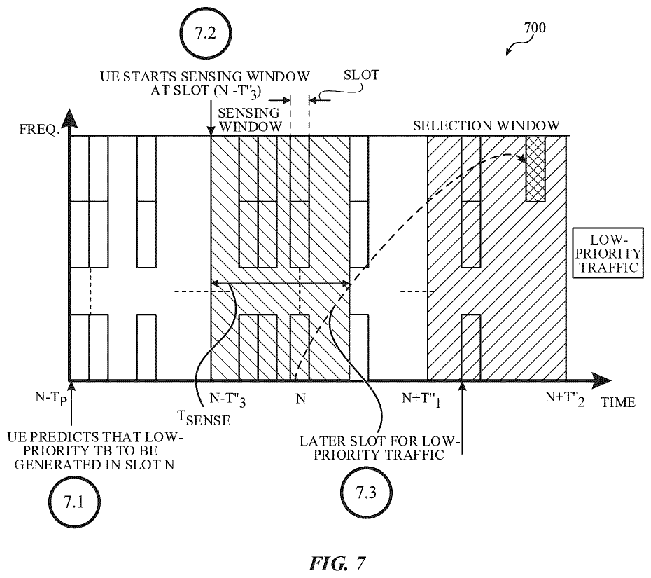

FIGS. 6-7 are diagrams of an examples of window start adaptation based on quality of service (QoS) according to one or more implementations described herein. Referring to example 600, UE 210 can be configured to determine or otherwise predict that a high-priority TB is to be generated in a given slot N (at 6.1). UE 210 can determine a sensing window and/or start monitoring the sensing window at a slot preceding slot N (e.g., at slot N−T′₃) (at 6.2). UE 210 can select and use time-frequency resources in a selection window for communicating via SL (at 6.3). As shown, the time-frequency resources can be an early slot due to the high priority of the traffic to be transmitted.

Referring to example 700, UE 210 can be configured to determine or otherwise predict that a low-priority TB is to be generated in a given slot N (at 6.1). UE 210 can determine a sensing window and/or start monitoring the sensing window at a slot preceding slot N (e.g., at slot N−T″₃) (at 7.2). Due to a lower priority transmission of example 700 relative to the higher priority transmission of example 600, the sensing window can be later in a time domain for the lower priority transmission. UE 210 can select and use time-frequency resources in a selection window for communicating via SL (at 7.3). As shown, the time-frequency resources can be a later slot due to the low priority of the traffic to be transmitted. Thus, UE 210 can select and use time-frequency resources in a selection window based on a priority level (e.g., a QoS or other type of quality-related metric or characteristic) of information to be transmitted via SL communications.

Referring to examples 600 and 700 more particularly, UE 210 can be configured with a sensing window duration Tₛₑₙₛₑ. UE 210 can predict at time (n−Tₚ) that a TB is to be generated at slot n, where Tₚ>=Tₛₑₙₛₑ corresponding to QoS class Q₁. UE 210 can also be configured with sensing start time for QoS class Q₁, T′₃. At a different time, UE 210 can predict at time (n−Tₚ) that a TB is to be generated at slot n, where Tₚ>=Tₛₑₙₛₑ corresponding to QoS class Q₂. UE can be configured with a sensing start time for QoS class Q₂, T″₃. UE 210 can be configured to start monitoring the channel at time (n−T″₃).

For example, when QoS Q₁ has higher priority than Q₂, then T′₃ can be set larger than T″₃. As such, by starting channel sensing earlier, UE 210 can be able to identify a transmission resource in the selection window that is earlier in time for higher-priority traffic than one for lower priority traffic. UE 210 can decode any 1st-stage SCI and identify potential occupied time-frequency resources in the selection window. UE 210 can be configured to identify transmit resources randomly form the remaining available resources.

A UE traffic prediction module can take one or more of the following inputs: UE orientation or pose; UE heading information; packet arrival time history; in-band SL positioning measurements; out-of-band sensor inputs such as Ultra-wideband wireless technology (UWB), radar, lidar, cameras, accelerometer, gyroscope, etc. UE traffic prediction module output can include next packet arrival time, packet/TB size, QoS or priority of next arriving packet, confidence level, etc. A network configuration can include: a sensing window start and end times (T₁, T₂) and frequency resources for sensing and selection windows. The network configuration can include a processing time (T_{proc}) can depend on UE category or UE capabilities reported by UE 210, and can include prediction model information (e.g., a model indenter (ID), parameters, etc.), prediction triggering conditions, etc. The network configuration can include a sensing window start time per QoS class (T′₃, T″₃).

Another implementation can include a sensing window extension for high-priority data. UE 210 can be configured to start sensing the channel early for high-priority data transmission. If at an end of the sensing window UE 210 determines that there are not enough available resources in the selection window to perform the data transmission, UE 210 can autonomously extend the sensing window by a pre-configured amount to increase the chances of finding sufficient resources for the data transmission.

The sensing window extension can also occur if UE 210 determines that the remaining resources in the selection window after removing the previously reserved resources and those that can be potentially utilized by other UEs 210, may result in higher than acceptable probability of collision with potential transmissions from other UEs 210 after random selection. For example, after removing all resources within the selection window that are previously reserve by other UEs 210, when UE 210 determines that there are only two acceptable resources from which to randomly select one, and that there may be other UEs 210 that may be attempting to transmit on some of those resources, then UE 210 can decide to extend the sensing window to discover more possible transmission resources in the selection window to decrease collision probability with other simultaneous transmissions. The network can previously configure UE 210 with multiple sensing window extension parameters for different QoS classes or data priorities.

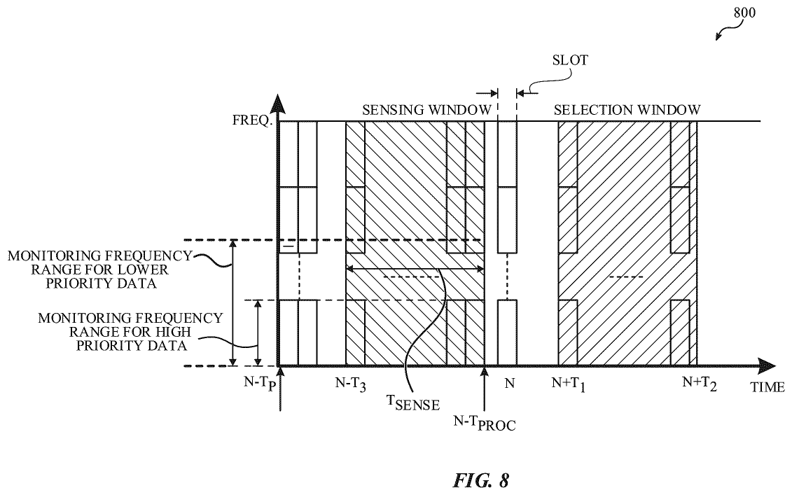

FIG. 8 is a diagram of an example 800 of QoS-influenced sensing frequency band adaptation according to one or more implementations described herein. UE 210 can be configured for QoS-influenced sensing frequency band adaptation. The frequency range over which UE 210 can monitor within the sensing window can be determined by the predicted QoS level of the next TB. Further, UE 210 can transmit the 1st-stage SCI in the same frequency range that UE 210 used for monitoring within the sensing window. When the next TB is predicted to belong to a high-priority QoS, UE 210 can monitor a small frequency region within the sensing window, whereas UE 210 can monitor a larger frequency region when the next TB is predicted to belong to a lower-priority QoS. The frequency range for the lower priority QoS can include the frequency range for the higher-priority QoS TB. Each UE 210 can be configured to monitor the frequency regions corresponding to all QoS levels higher than its next predicted TB transmission before determining the resources for transmission. By monitoring only frequency regions corresponding to a predicted QoS level and higher levels, a next transmission of UE 210 can overlap with lower-priority transmissions of other UEs 210.

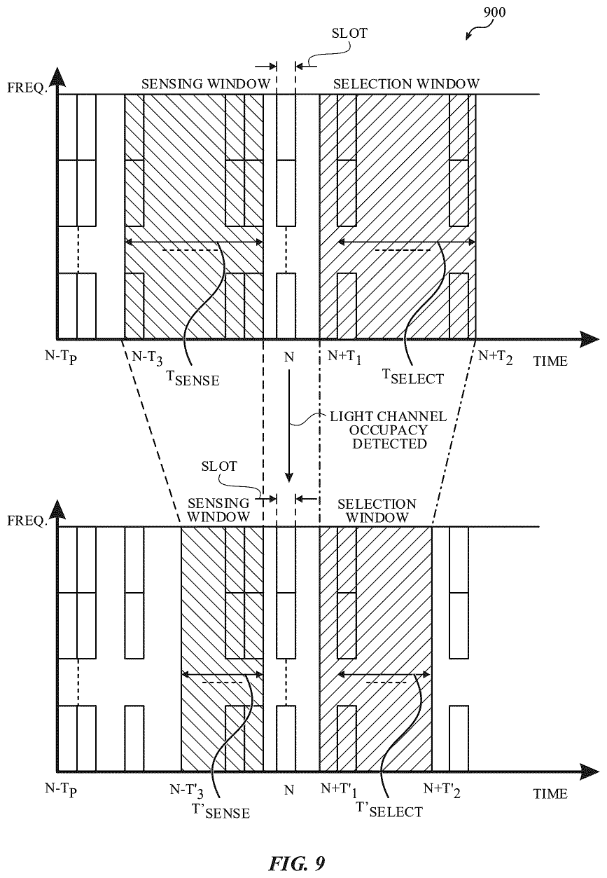

FIG. 9 is a diagram of an example 900 of activity sensing based on window size adaptation according to one or more implementations described herein. UE 210 can be configured with default sensing and selection window durations Tₛₑₙₛₑ and T_{select} and another set of sensing and selection window durations T′ₛₑₙₛₑ and T′_{select} and, to use when channel is lightly occupied. UE 210 can monitor channel activity (e.g., in terms of channel occupancy) cither via channel sensing, by reading the 1st-stage SCI, or by a combination of both methods. A traffic predictor at the UE 210 can predicts at time (n−Tₚ) that a TB is to be generated at slot n, where Tₚ>=Tₛₑₙₛₑ, and channel occupancy predictor estimates that the channel occupancy will be low.

UE 210 can then switch from sensing window duration Tₛₑₙₛₑ to T′ₛₑₙₛₑ, and selection window duration from to T_{select} and T′_{select}. UE 210 can be configured to revert back to the default window sizes when, for example, one or more of the following conditions is satisfied: a channel occupancy predictor estimates high channel occupancy for a following TB transmission; a TB transmission using smaller windows results in collision and no transmission resources are available after elimination for potential occupancy based on sensing. UE 210 can switch a sensing window duration and a selecting window direction when a channel occupancy predictor estimates that a channel occupancy is to be below a channel occupancy threshold. UE 210 can also, or alternatively, revert back to a default windows size when a channel occupancy predictor estimates a high channel occupancy for a TB transmission, a TB transmission using smaller windows results in collision, no transmission resources are available after elimination for potential occupancy based on sensing, or a combination thereof. UE 210 can be configured to adapt the sensing window alone or both the sensing and the selection windows by the network. For example, upon detecting low channel occupancy, UE 210 may be configured by the network to switch from the default sensing window duration, Tₛₑₙₛₑ, to the second configured sensing window duration, T′ₛₑₙₛₑ. Alternatively, upon detecting low channel occupancy, UE 210 may be configured by the network to switch from the default sensing window duration, Tₛₑₙₛₑ, to the second configured sensing window duration, T′ₛₑₙₛₑ and also from the default selection window duration, T_{select}, to the second configured selection window duration, T′_{select}. UE 210 can be configured by the network with multiple sensing and selection window size settings corresponding to different channel occupancy levels.

A UE traffic prediction module can take one or more of the following inputs: UE orientation or pose; UE heading information; packet arrival time history; in-band SL positioning measurements; out-of-band sensor inputs such as Ultra-wideband wireless technology (UWB), radar, lidar, cameras, accelerometer, gyroscope, etc. UE traffic prediction module output can include next packet arrival time, confidence level, etc. A network configuration can include: a sensing window start time (T₃); selection window start and end times (T₁, T₂). Processing time (T_{proc}) can depend on UE category or UE capabilities reported by UE 210. Prediction model info can include model indenter (ID), parameters, etc.), prediction triggering conditions, etc.

A channel occupancy prediction module can take one or more of the following inputs: ahistorical channel energy measurements in the sensing window (e.g., reference signal received power (RSRP), signal-to-noise ratio (SINR), etc.). historical 1st-stage SCI information, historical channel occupancy within selection window based on energy measurements, historical packet collision information, etc. A channel occupancy prediction module output can include: a channel occupancy level (e.g., high/low, or multiple levels), prediction confidence level, etc. A network configuration can include a sensing window durations for different channel occupancy levels (e.g., high/low, or multiple levels), prediction model information (e.g., a model ID, parameters, etc.), prediction triggering conditions (e.g., for certain UE categories, for certain QoS classes, etc.), a fallback to default configuration conditions.

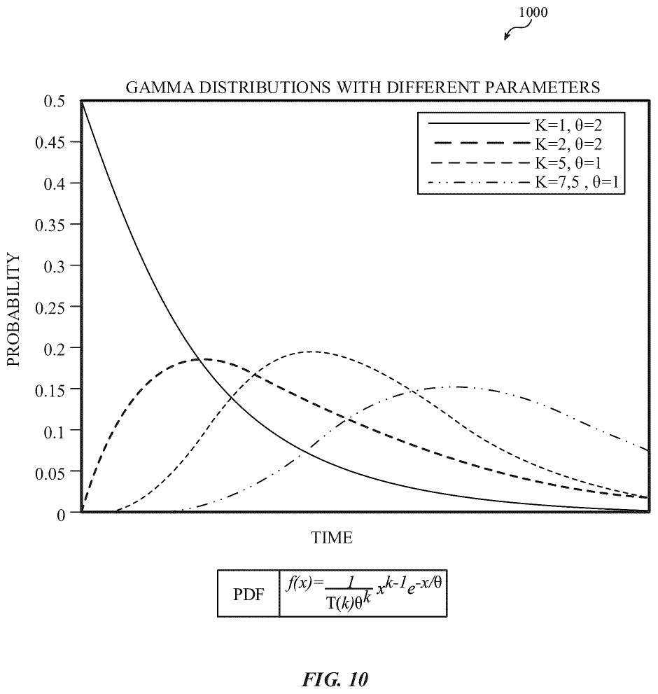

FIG. 10 is a diagram of an example 1000 of gamma distributions with different parameters according to one or more implementations described herein. Example 1100 can include a time domain along a horizontal axis and a probabilities index along a vertical axis. A proximities density function (PDF) can be expressed as follows.

$$f ( x ) = \frac{1}{T ( k ) {θ}^{k}} {x}^{k - 1} {e}^{- x / θ}$$

k can be a shape parameter for the gamma distribution, θ can be a scale parameter, x can be the random variable and Γ (represented above as simply “T”) can be the gamma function. UE 210 can be configured with default sensing and selection window durations Tₛₑₙₛₑ and T_{select}. UE 210 can decode any 1st-stage SCI and determine the transmission schedule for the associated TB. After identifying and excluding the potentially occupied time-frequency resources in the selection window based on decoded transmission schedules, UE 210 can be left with candidate resources for transmissions. UE 210 can bias the choice of transmission resources from the candidate resources within the selection window according to the priority of the pending TB or estimated channel occupancy. For example, UE 210 can apply a non-uniform probability distribution while choosing the transmission resources such that candidate resources that occur earlier in time are favored for high-priority traffic and later resources within the selection window are favored for low-priority traffic. For example, UE 210 can apply a gamma distribution or exponential distribution with different parameters for different priority traffic. The distribution type and the parameters for different traffic types or priorities can be configured by the network.

An alternative, or additional, implementation can include an option is to build AI/ML models to predict idle periods (i.e., periods in which continuous channel sensing could be stopped). UE 210 can perform continuous channel sensing except in idle periods determined by the prediction model. This mode can provide a compromise solution between continues channel sensing and need-based sensing as UE 210 can enter a sleep or power saving mode for specific periods. UE 210 can be configured to switch between different modes as, for example, described below.

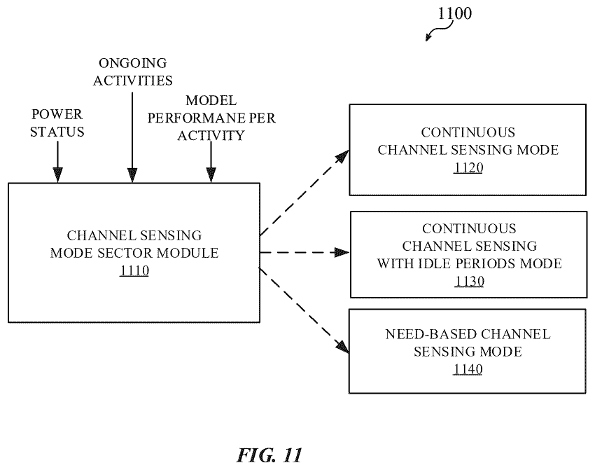

FIG. 11 is a diagram of an example 1100 of channel sensing mode selection according to one or more implementations described herein. As shown, example, 1100 can include channel sensing mode selector module 1110, continuous channel sensing mode 1120, continuous channel sensing with idle periods mode 1130, and need-based channel sensing mode 1140. Channel sensing mode selector module 1110 can be installed on and executed by UE 210. Channel sensing mode selector module 1110 can cause or enable UE 210 to switch between different modes of operation (e.g., continuous channel sensing mode 1120, continuous channel sensing with idle periods mode 1130, and need-based channel sensing mode 1140) based on one or more factors, conditions, thresholds, or inputs, such as a power status (e.g., a current amount of batter power of UE 210), a type, category, or priority of activities being performed by UE 210 (e.g., a QoS associated with a TB, channel, dataflow, etc.), and/or a model performance per activity. A model performance can include an output inference generated by an AI/ML model being executed by UE 210 or channel sensing mode selector module 1110.

UE 210 can switch between the different modes of sensing (e.g., continuous channel sensing, continuous sensing with idle periods, need based channel sensing, etc.) based on different factors, conditions, or thresholds. Examples of these factors, conditions, or thresholds can include a power status (e.g., with low batter power and while in a power saving mode a need-based channel sensing can be preferred); ongoing activities (e.g., for ultra-low latency activities, a continuous channel sensing can be preferred); and model performance can be different based on the ongoing activities (e.g., when new applications is installed, a prediction model can take time to perform well, in such case continuous channel sensing can be preferred for a time). A channel sensing mode selector module 1110 can select the channel sensing mode that achieve a best user experience (including both power and performance aspects). When continuous sensing with idle periods or need-based channel sensing mode is selected, channel sensing mode selector module 1110 can provide the system with the accepted prediction confidence value.

UE 210 can be configured to transmit a packet on via SL roughly every 20 millisecond (ms). A shortened sensing window length can be 10 ms. A PSCCH can be 2 symbols with a slot length of 1 ms. Energy consumed by a traffic predictor can involve a long short-term memory (LSTM) recurrent neural network prediction with 40 hidden layers and 8 input features, can be 3.7 picojoules (pJ) of energy consumption per 32-bit floating point multiplication on 45 nanometer process technology. The prediction cost per traffic packet can be 0.0286 millijoules (mJ).

Energy consumed for additional channel monitoring for 10 ms per packet, when traffic prediction is not deployed (existing case), can include power expended for a single PSCCH monitoring (adapted from 2) can be 2 watt; and energy expended for monitoring PSCCH for 10 ms can be 5.7 mJ. Therefore, halving the sensing duration, roughly translates into halving the energy consumption since the additional energy cost of predicting transmissions is relatively small. Extending the analysis to lower duty cycles (e.g., when incoming packets are farther apart) can result in greater energy savings, primarily limited by the traffic prediction horizon. In addition to sensing the channel before transmitting, UE 210 in SL communications can monitor the channel for incoming transmissions as well. Monitoring the PSCCH for incoming transmissions can reduce the energy gains of the proposed prediction method.

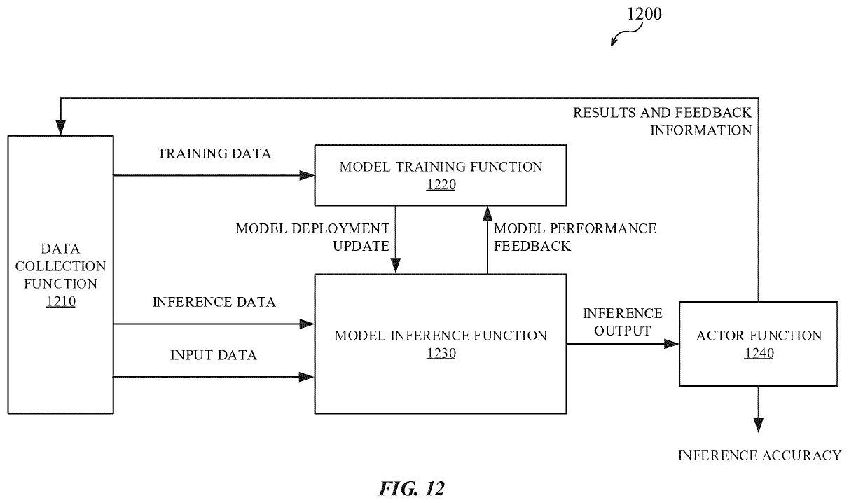

FIG. 12 is a diagram of an example of AI/ML functions 1200 according to one or more implementations described herein. As shown, example 1200 can include data collection function 1210, model training function 1220, model inference function 1230, and actor function 1240. In some implementations, AI/ML functions 1200 can include one or more, fewer, alternative, or alternatively arranged functions than those depicted. Aspects of AI/ML functions 1200 can be implemented by one or more devices, such as UE 210, RAN node 222 (e.g., a base station), network elements of CN 230, AI/ML model servers 270, or a combination thereof. For example, AI/ML model servers 270 can implement aspects of AI/ML functions 1200 to generate, train, test, and evaluate AI/ML models. The AI/ML models can be distributed to UE 210, and UE can implement one or more aspects of AI/ML functions 1200 for AI/ML model deployment, evaluation, and feedback generation. AI/ML model servers 270 can implement aspects of AI/ML model functionality to update AI/ML models, retrain AI/ML models, and send modified versions of AI/ML models to UE 210. The AI/ML models can be configured and trained to operate under specified conditions and generate certain types of inferences relating to UE 210, RAN node 222 (e.g., a base station), and/or communications between UE 210 and RAN node 222 (e.g., a base station).

Data collection function 1210 can provide input data to model training function 1220 and model inference function 1230. Examples of input data can include measurements from UEs 210 or different network entities, feedback from actor function 1240, output from an AI/ML model. As described herein, an AI/ML model can include a framework of functions, vectors, and/or other types of features that have been trained by applying training data to the AI/ML model. The AI/ML model can be capable of evaluating input data and producing output data interpreted as an inference derived from input data applied to the AI/ML model.

Training data can include input data for the AI/ML model training function 1220. Model training function 1220 can perform AI/ML model training, validation, and testing which can generate model performance metrics as part of a model testing procedure. Model training function 1220 can also be responsible for data preparation (e.g., data pre-processing and cleaning, formatting, and transformation) based on training data delivered by a data collection function 1210. A model deployment/update can be used to initially deploy a trained, validated, and tested AI/ML model to model inference function 1230 or to deliver an updated model to model inference function 1230.

Model inference function 1230 can implement an AI/ML model to produce an inference output based on input data provided to model inference function 1230. The input data can be provided by a device executing data collection function, which can be the same or a different device performing model inference function 1230. Model inference function 1230 can also perform for data preparation procedures (e.g., data pre-processing, cleaning, formatting, and transformation) based on inference data provided by data collection function 1210. Model inference function 1230 can generate and provide model performance feedback to model training function 1220 when applicable. The model performance feedback can be used evaluate the performance of an AI/ML model, which can lead to the AI/ML model being updated and/or retrained depending on an accuracy of the output inference.

Actor function 1240 can receive an inference output from the model inference function 1230 and perform one or more procedures using the inference output. Actor function 1240 can include a function configured to use or evaluate the inference output of model inference function 1230 in one or more ways. For example, input data provided to model inference function 1230 can also be provided to a non-NN procedure. Model inference function 1230 can produce an inference output intended to predict or anticipate the output produced by the non-NN procedure. Actor function 1240 can perform the non-NN procedure, using the same input data used by model inference function 1230, to produce output data of the non-NN procedures.

Actor function 1240 can apply one or more data processing, evaluation, and analysis functions or tools to the inference output and/or the output of the non-NN procedure to determine an inference accuracy of the AI/ML model (e.g., whether the AI/ML model accurately predicted the output of the non-NN procedure). Actor function 1240 can also determine whether one or more additional inputs or conditions are appropriate for using the AI/ML model based on an inference accuracy of the interference output. Actor function 1240 can produce results, feedback, and other information that can be used to derive training data, inference data, or monitor the performance of the AI/ML model and its impact on one or more device, such as UE 210, RAN node 222 (e.g., a base station), etc.

An inference output can include a prediction of TB generation and/or a QoS of a predicted TB. A SL-capable UE operating in mode 2 can predict an arrival of a TB in a buffer of the UE and can initiate monitoring of a channel for a configured duration before the predicted arrival of the TB. In another example, a sensing and selection window size can be adapted based on traffic QoS. The UE can dynamically adapt the sensing and selection windows based on a predicted priority or QoS of the future TBs. Inference outputs can also, or alternatively be used to determine and dynamically adjust a size of a future sensing window and/or further selection window. Inference outputs can also, or alternatively be used to predict idle periods and determine when a relaxation mode is to be implemented. Inference outputs can also, or alternatively be used to determine when UE 210 is to switch between different modes of operations, such as between continuous and discontinuous sensing based on various factors including power status.

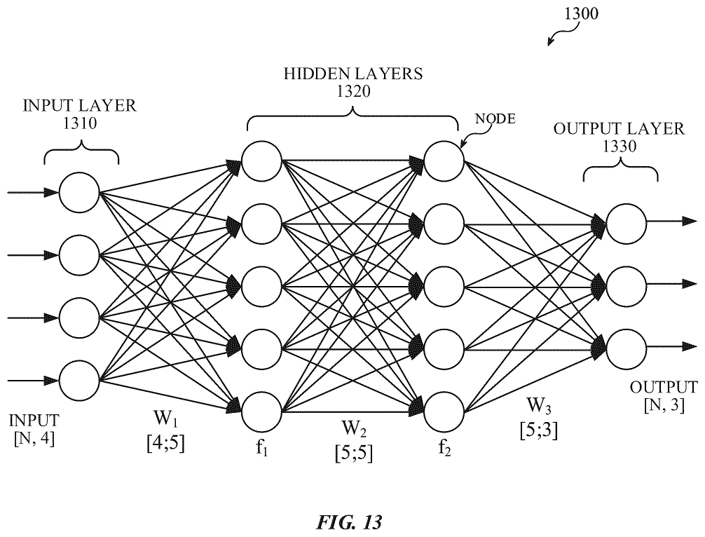

FIG. 13 is a diagram of an example of AI/ML model 1300 according to one or more implementations described herein. As shown, AI/ML model 1300 can include nodes arranged in different layers, such as an input layer 1310, multiple hidden or intermediary layers 1320 of nodes, and an output layer 1330 of nodes. In some implementations, AI/ML model 1300 can be an example of, or a portion of, model training function 1320, an AI/ML model, model inference function 1330, and/or actor function 1340. For example, AI/ML model 1300 can be trained on training data from a data collection function, deployed by a model training function as an AI/ML model, and used by a model inference function to produce feedback for model training function 1320 and an inference output for actor function.

Example AI/ML model 1300 can include a number N of inputs introduced to four input nodes [N, 4] of input layer 1310. This can include processing or encoding input data into a form, shape, vector, or data structure, that is receivable by the AI/ML model. The four input nodes can process the inputs to produce a first weight (W₁) that the four input nodes provide to the five nodes [4; 4] of a first hidden layer. The five nodes of the first hidden layer can use a first function (f₁) to process the inputs to produce a second weight (W₂) that the five nodes of the first hidden layer can provide to the five nodes [4; 4] of a second hidden layer. The five nodes of the second layer can use a second function (f₂) to process the inputs to produce a third weight (W₃) that the five nodes of the second hidden layer can provide to the three nodes [4;3] of output layer 1330. The nodes of output layer 1330 can each process the inputs received and produce an output. This can include converting or unencoding output data from a form, shape, vector, or data structure, that can be used by a subsequent algorithm, process, or procedure.

One or more of the techniques described herein as using a NN, an AI/ML model, and the like, can be implemented using any type or combination of artificial intelligence (AI). Generally, AI can involve a combination of computer science and datasets to enable problem-solving. AI can encompass machine learning (ML) and deep learning (DL). These disciplines are comprised of AI algorithms that seek to create expert systems which make predictions or classifications based on input data. ML, DL, and neural networks (NNs) can be viewed as sub-fields of AI. However, NNs can actually be a sub-field of ML, and DL can be a sub-field of NNs. The way in which DL and ML differ can include in how each algorithm learns. Deep ML can use labeled datasets (also known as supervised learning) to inform its algorithm but may not necessarily involve a labeled dataset. DL can ingest unstructured data in a raw form (e.g., text or images) and can automatically or autonomously determine the set of features that distinguish different categories of data from one another. This can eliminate some of the human intervention otherwise involved and enable use of larger data sets. DL can be viewed, in a sense, as scalable ML.

NNs, or artificial NNs (ANNs), can comprise logically interconnected nodes arranged in node layers. There can be an input layer, one or more hidden or intermediate layers, and an output layer. Each node, or artificial neuron, can connect to another and has an associated weight and threshold. If the output of any individual node is above the specified threshold value, that node is activated, sending data to the next layer of the network. Otherwise, no data can be passed along to the next layer of the network by that node. The “deep” in deep learning can refer to the number of layers in an NN. An AI/ML model with more than three layers—which would be inclusive of the input and the output—can be considered a deep learning algorithm or a deep NN. A NN model with only three layers can be viewed as a basic NN.

A NN can be a feed forward NN (FNN) or a recurrent NN (RNN). Examples of a FFN can include linear functions, such as a convolutional NN (CNN) or a NN that uses a radial basis function network. A CNN can include a framework capable of discovering NN features using filter or kernel optimization and producing an output. These NNs can harness principles from linear algebra, particularly matrix multiplication, to identify patterns within an image. Linear regression analysis, for example, can be used to predict a value of a variable based on a value of another variable. This form of analysis can estimate coefficients of a linear equation, involving one or more independent variables that best predict the value of the dependent variable. Linear regression can fit a straight line or surface that minimizes discrepancies between a predicted value and an actual value. These learning algorithms can be leveraged when using time-series data to make predictions about future outcomes.

An NN using a radial basis function network can be a linear combination of radial basis functions of inputs and neuron parameters. Radial basis function networks can be used for function approximation, time series prediction, classification, and system control. An RNN can be a bi-directional (as opposed to a linear) NN. A RNN can allow the output from some nodes to affect a subsequent input to the same nodes, thus having feedback loops and the potential for infinite impulse response compared to the finite impulse response of the more linear CNN.

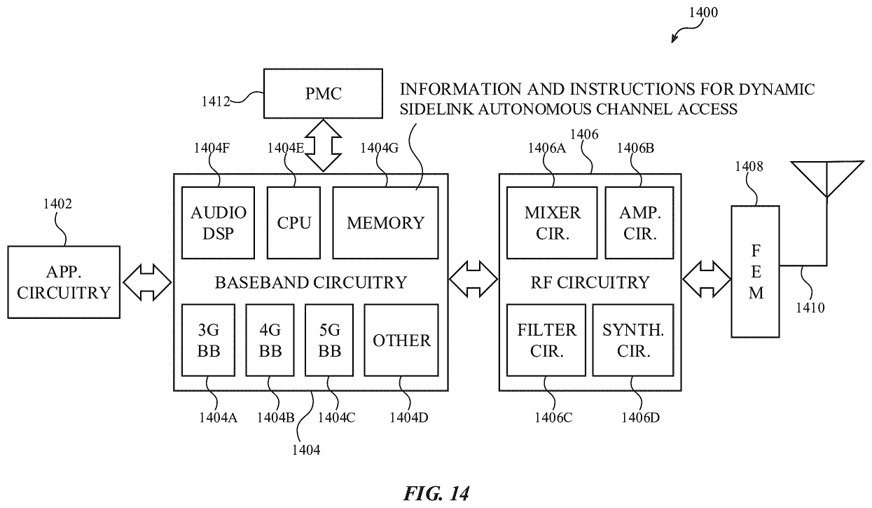

FIG. 14 is a diagram of an example of components of a device 1400 according to one or more implementations described herein. In some implementations, device 1400 can include application circuitry 1402, baseband circuitry 1404, RF circuitry 1406, front-end module (FEM) circuitry 1408, one or more antennas 1410, and power management circuitry (PMC) 1412 coupled together at least as shown. In some implementations, device 1400 can include fewer elements (e.g., a RAN node may not utilize application circuitry 1402 and can instead include a processor/controller to process data received from a core network. In some implementations, device 1400 can include additional elements such as, for example, memory/storage, display, camera, sensor (including one or more temperature sensors, such as a single temperature sensor, a plurality of temperature sensors at different locations in device 1400, etc.), or input/output (I/O) interface. In other implementations, the components described below can be included in more than one device (e.g., said circuitries can be separately included in more than one device for cloud-RAN (C-RAN) implementations).

Application circuitry 1402 can include one or more application processors. For example, application circuitry 1402 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on device 1400. In some implementations, processors of application circuitry 1402 can process data packets received from a core network.

Baseband circuitry 1404 can include circuitry such as, but not limited to, one or more single-core or multi-core processors. Baseband circuitry 1404 can include one or more baseband processors or control logic to process baseband signals received from a receive signal path of RF circuitry 1406 and to generate baseband signals for a transmit signal path of RF circuitry 1406. Baseband circuitry 1404 can interface with application circuitry 1402 for generation and processing of the baseband signals and for controlling operations of RF circuitry 1406. For example, in some implementations, baseband circuitry 1404 can include a 3G baseband processor 1404A, a 4G baseband processor 1404B, a 5G baseband processor 1404C, or other baseband processor(s) 1404D for other existing generations, generations in development or to be developed in the future (e.g., 5G, 6G, 7G, etc.). Baseband circuitry 1404 (e.g., one or more of baseband processors 1404A-D) can handle various radio control functions that enable communication with one or more radio networks via RF circuitry 1406. In other implementations, some or all of the functionality of baseband processors 1404A-D can be included in modules stored in memory 1404G and executed via a central processing unit (CPU) 1404E. The radio control functions can include, but are not limited to, signal modulation/demodulation, encoding/decoding, radio frequency shifting, etc. In some implementations, modulation/demodulation circuitry of baseband circuitry 1404 can include Fast-Fourier Transform (FFT), precoding, or constellation mapping/de-mapping functionality. In some implementations, encoding/decoding circuitry of baseband circuitry 1404 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 1404G can receive and/or store information and instructions for dynamic SL autonomous channel selection access. UE 210 can initiate a sensing window based on a prediction of TB generation. A SL-capable UE 210 operating in mode 2 can predict an arrival of a TB in a buffer of UE 210 and can initiate monitoring of the channel for a configured duration before the predicted arrival of the TB. A sensing and selection window size can be adapted based on traffic QoS. UE 210 can dynamically adapt the sensing and selection windows based on a predicted priority or QoS of the future TBs. These and many other features and examples are described herein.

In some implementations, baseband circuitry 1404 can include one or more audio digital signal processor(s) (DSP) 1404F. Audio DSP 1404F can include elements for compression/decompression and echo cancellation and can include other suitable processing elements in other implementations. Components of baseband circuitry 1404 can be suitably combined in a single chip, a single chipset, or disposed on a same circuit board in some implementations. In some implementations, some or all of the constituent components of baseband circuitry 1404 and application circuitry 1402 can be implemented together such as, for example, on a system on a chip (SOC).

In some implementations, baseband circuitry 1404 can provide for communication compatible with one or more radio technologies. For example, in some implementations, baseband circuitry 1404 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which baseband circuitry 1404 is configured to support radio communications of more than one wireless protocol can be referred to as multi-mode baseband circuitry.

RF circuitry 1406 can enable communication with wireless networks using modulated electromagnetic radiation through a non-solid medium. In various implementations, RF circuitry 1406 can include switches, filters, amplifiers, etc., to facilitate the communication with the wireless network. RF circuitry 1406 can include a receive signal path which can include circuitry to down-convert RF signals received from FEM circuitry 1408 and provide baseband signals to baseband circuitry 1404. RF circuitry 1406 can also include a transmit signal path which can include circuitry to up-convert baseband signals provided by baseband circuitry 1404 and provide RF output signals to FEM circuitry 1408 for transmission.

In some implementations, the receive signal path of RF circuitry 1406 can include mixer circuitry 1406A, amplifier circuitry 1406B and filter circuitry 1406C. In some implementations, the transmit signal path of RF circuitry 1406 can include filter circuitry 1406C and mixer circuitry 1406A. RF circuitry 1406 can also include synthesizer circuitry 1406D for synthesizing a frequency for use by mixer circuitry 1406A of the receive signal path and the transmit signal path. In some implementations, mixer circuitry 1406A of the receive signal path can be configured to down-convert RF signals received from FEM circuitry 1408 based on the synthesized frequency provided by synthesizer circuitry 1406D. Amplifier circuitry 1406B can be configured to amplify the down-converted signals and filter circuitry 1406C can be a low-pass filter (LPF) or band-pass filter (BPF) configured to remove unwanted signals from the down-converted signals to generate output baseband signals. Output baseband signals can be provided to baseband circuitry 1404 for further processing. In some implementations, the output baseband signals can be zero-frequency baseband signals, although this may not be a requirement. In some implementations, mixer circuitry 1406A of the receive signal path can comprise passive mixers, although the scope of the implementations is not limited in this respect.

In some implementations, mixer circuitry 1406A of the transmit signal path can be configured to up-convert input baseband signals based on the synthesized frequency provided by synthesizer circuitry 1406D to generate RF output signals for FEM circuitry 1408. The baseband signals can be provided by baseband circuitry 1404 and can be filtered by filter circuitry 1406C. In some implementations, mixer circuitry 1406A of the receive signal path and mixer circuitry 1406A of the transmit signal path can include two or more mixers and can be arranged for quadrature down conversion and up conversion, respectively. In some implementations, mixer circuitry 1406A of the receive signal path and mixer circuitry 1406A of the transmit signal path can include two or more mixers and can be arranged for image rejection. In some implementations, mixer circuitry 1406A of the receive signal path and mixer circuitry 1406A can be arranged for direct down conversion and direct up conversion, respectively. In some implementations, mixer circuitry 1406 of the receive signal path and mixer circuitry 1406A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 1406 can include analog-to-digital converter (ADC) and digital-to-analog converter (DAC) circuitry and baseband circuitry 1404 can include a digital baseband interface to communicate with RF circuitry 1406.

In some dual-mode implementations, a separate radio IC circuitry can be provided for processing signals for each spectrum, although the scope of the implementations is not limited in this respect. In some implementations, synthesizer circuitry 1406D can be a fractional-N synthesizer or a fractional N/N+1 synthesizer, although the scope of the implementations is not limited in this respect as other types of frequency synthesizers can be suitable. For example, synthesizer circuitry 1406D can be a delta-sigma synthesizer, a frequency multiplier, or a synthesizer comprising a phase-locked loop with a frequency divider.

Synthesizer circuitry 1406D can be configured to synthesize an output frequency for use by mixer circuitry 1406A of RF circuitry 1406 based on a frequency input and a divider control input. In some implementations, synthesizer circuitry 1406D can be a fractional N/N+1 synthesizer. In some implementations, frequency input can be provided by a voltage-controlled oscillator (VCO). Divider control input can be provided by either baseband circuitry 1404 or the applications circuitry 1402 depending on the desired output frequency. In some implementations, a divider control input (e.g., N) can be determined from a look-up table based on a channel indicated by the applications circuitry 1402.

Synthesizer circuitry 1406D of RF circuitry 1406 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1406D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 1406 can include an in-phase/quadrature (I/Q)/polar converter.

FEM circuitry 1408 can include a receive signal path which can include circuitry configured to operate on RF signals received from one or more antennas 1410, amplify the received signals and provide the amplified versions of the received signals to RF circuitry 1406 for further processing. FEM circuitry 1408 can also include a transmit signal path which can include circuitry configured to amplify signals for transmission provided by RF circuitry 1406 for transmission by one or more of the one or more antennas 1410. In various implementations, the amplification through the transmit or receive signal paths can be done solely in RF circuitry 1406, solely in FEM circuitry 1408, or in both RF circuitry 1406 and FEM circuitry 1408.

In some implementations, FEM circuitry 1408 can include a transmit/receive switch to switch between transmit mode and receive mode operation. FEM circuitry 1408 can include a receive signal path and a transmit signal path. The receive signal path of FEM circuitry 1408 can include a low noise amplifier to amplify received RF signals and provide the amplified received RF signals as an output (e.g., to RF circuitry 1406). The transmit signal path of FEM circuitry 1408 can include a power amplifier to amplify input RF signals (e.g., provided by RF circuitry 1406), and one or more filters to generate RF signals for subsequent transmission (e.g., by one or more of one or more antennas 1410).

In some implementations, PMC 1412 can manage power provided to baseband circuitry 1404. In particular, PMC 1412 can control power-source selection, voltage scaling, battery charging, or direct current (DC) to DC (DC-to-DC) conversion. PMC 1412 can often be included when device 1400 is capable of being powered by a battery, for example, when device 1400 is included in a UE. PMC 1412 can increase the power conversion efficiency while providing desirable implementation size and heat dissipation characteristics.

While FIG. 14 shows PMC 1412 coupled only with baseband circuitry 1404. However, in other implementations, PMC 1412 can be additionally or alternatively coupled with, and perform similar power management operations for, other components such as, but not limited to, application circuitry 1402, RF circuitry 1406, or FEM circuitry 1408.

In some implementations, PMC 1412 can control, or otherwise be part of, various power saving mechanisms of device 1400. For example, if device 1400 is in an RRC_Connected state, where device 1400 is still connected to the RAN node as device 1400 expects to receive traffic shortly, then device 1400 can enter a state known as discontinuous reception mode (DRX) after a period of inactivity. During this state, device 1400 can power down for brief intervals of time and thus save power.

If there is no data traffic activity for an extended period of time, then device 1400 can transition off to an RRC_Idle state, where device 1400 disconnects from the network and does not perform operations such as channel quality feedback, handover, etc. Device 1400 can go into a very low power state and device 1400 can perform paging where again device 1400 periodically can wake up to listen to the network and then power down again. Device 1400 may not receive data in this state; in order to receive data, device 1400 can transition back to RRC_Connected state.

An additional power saving mode can allow a device to be unavailable to the network for periods longer than a paging interval (ranging from seconds to a few hours). During this time, the device 1400 can be unreachable to the network and can power down completely. Any data sent during this time can incur a large delay and device 1400 can assume the delay is acceptable.

Processors of application circuitry 1402 and processors of baseband circuitry 1404 can be used to execute elements of one or more instances of a protocol stack. For example, processors of baseband circuitry 1404, alone or in combination, can be used execute Layer 3, Layer 2, or Layer 1 functionality, while processors of baseband circuitry 1404 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

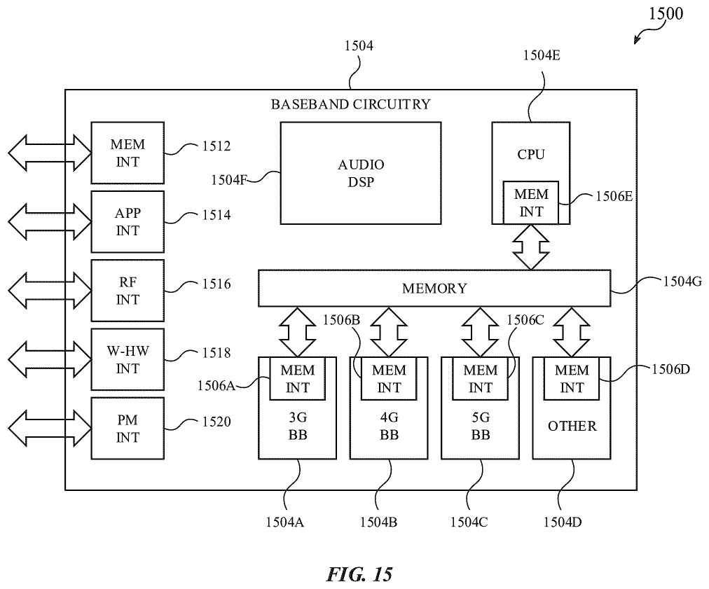

FIG. 15 is a diagram of example interfaces 1500 of baseband circuitry according to one or more implementations described herein. One or more components or features of example interfaces 1500 can correspond to one or more components or features described above or elsewhere. Baseband circuitry 1504 can comprise processors 1504A, 1504B, 1504C, 1504D, and 1504E and a memory 1504G utilized by said processors. Each of processors 1504A, 1504B, 1504C, 1504D, and 1504E can include a memory interface, 1506A, 1506B, 1506C, 1506D, and 1506E, respectively, to send/receive data to/from memory 1504G. Baseband circuitry can be a component of a UE and/or another type of device or system capable of transmitting and/or receiving wireless signals.

Baseband circuitry 1504 can further include one or more interfaces to communicatively couple to other circuitries/devices, such as memory interface 1512 (e.g., an interface to send/receive data to/from memory external to baseband circuitry 1504), an application circuitry interface 1514 (e.g., an interface to send/receive data to/from the application circuitry as described herein), an RF circuitry interface 1516, a wireless hardware connectivity interface 1518 (e.g., an interface to send/receive data to/from near field communication components, Bluetooth® components (e.g., Bluetooth® Low Energy), Wi-Fi® components, and other communication components), and a power management interface 1520 (e.g., an interface to send/receive power or control signals to/from a PMC).

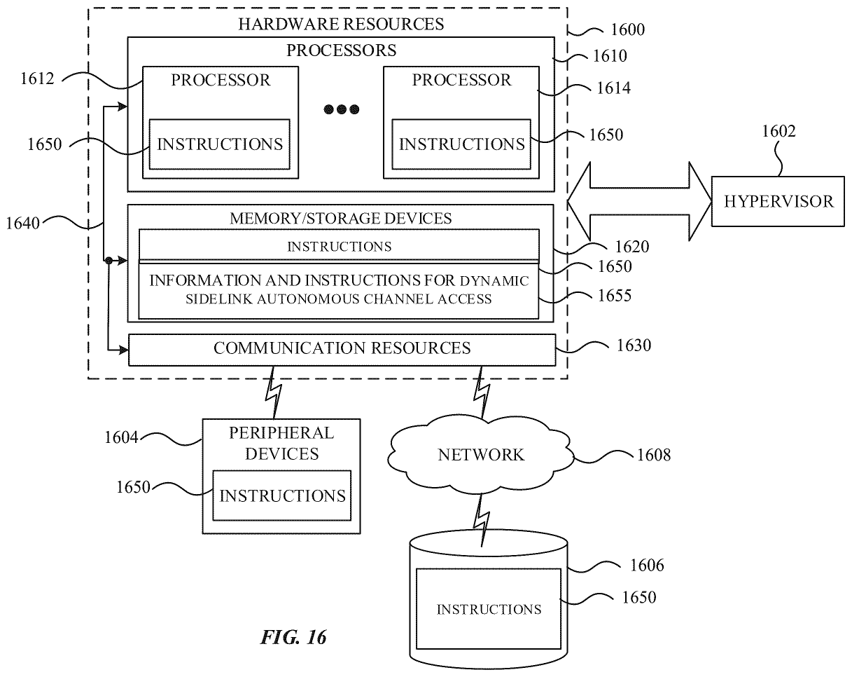

FIG. 16 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 16 shows a diagrammatic representation of hardware resources 1600 including one or more processors 1610 (or processor cores), one or more memory/storage devices 1620, and one or more communication resources 1630, each of which can be communicatively coupled via a bus 1640. For implementations where node virtualization or network function virtualization is utilized, a hypervisor can be executed to provide an execution environment for one or more network slices/sub-slices to utilize hardware resources 1600. Hardware resources 1600 can interact with hypervisor 1602. For example, hypervisor 1602 can schedule or otherwise manage hardware resource 1600.

Processors 1610 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1612 and a processor 1614.

Memory/storage devices 1620 can include main memory, disk storage, or any suitable combination thereof. Memory/storage devices 1620 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), flash memory, solid-state storage, etc.

In some implementations, memory/storage devices 1620 receive and/or store information and instructions 1655 for dynamic SL autonomous channel selection access. UE 210 can initiate a sensing window based on a prediction of TB generation. A SL-capable UE 210 operating in mode 2 can predict an arrival of a TB in a buffer of UE 210 and can initiate monitoring of the channel for a configured duration before the predicted arrival of the TB. A sensing and selection window size can be adapted based on traffic QoS. UE 210 can dynamically adapt the sensing and selection windows based on a predicted priority or QoS of the future TBs. These and many other features and examples are described herein.

Communication resources 1630 can include interconnection or network interface components or other suitable devices to communicate with one or more peripheral devices 1604 or one or more databases 1606 via a network 1608. For example, communication resources 1630 can include wired communication components (e.g., for coupling via a universal serial bus), cellular communication components, near field communication components, Bluetooth® components (e.g., Bluetooth® Low Energy), Wi-Fi® components, and other communication components.

Instructions 1650A, 1650B, 1650C, 1650D, and/or 1650E can comprise software, a program, an application, an applet, an app, or other executable code for causing at least any of processors 1610 to perform any one or more of the methodologies discussed herein. Instructions 1650 can reside, completely or partially, within at least one of processors 1610 (e.g., within a cache memory), memory/storage devices 1620, or any suitable combination thereof. Furthermore, any portion of instructions 1650A-E can be transferred to hardware resources 1600 from any combination of peripheral devices 1604 or databases 1606. Accordingly, memory of processors 1610, memory/storage devices 1620, peripheral devices 1604, and databases 1606 are examples of computer-readable and machine-readable media.

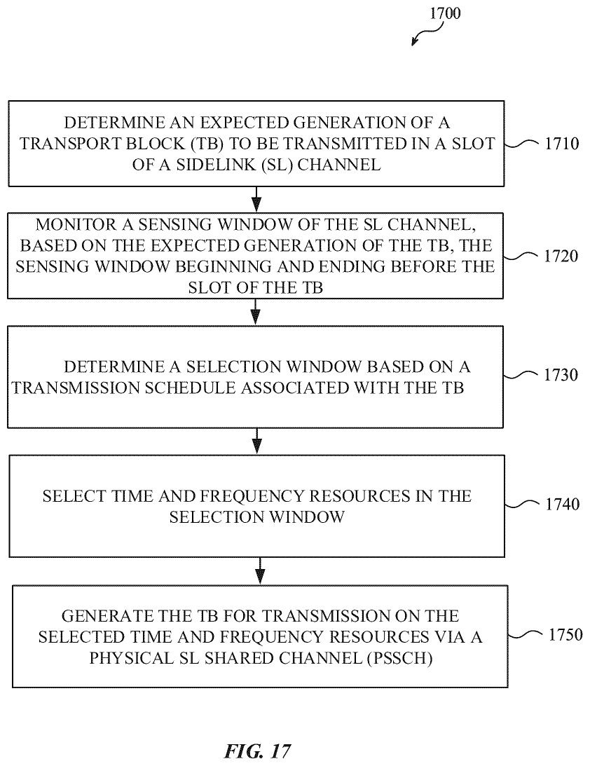

FIG. 17 is a diagram of an example process 1700 for dynamic SL autonomous channel access according to one or more implementations described herein. Process 1700 can be implemented by UE 210 or one or more components thereof, such as baseband circuitry 1206, RF circuitry 1208, etc. In some implementations, some or all of process 1700 can be performed by one or more other systems or devices, including one or more of the devices of FIG. 2. Additionally, process 1700 can include one or more fewer, additional, differently ordered and/or arranged operations than those shown in FIG. 17. In some implementations, some or all of the operations of process 1700 can be performed independently, successively, simultaneously, etc., of one or more of the other operations of process 1700. As such, the techniques described herein are not limited to a number, sequence, arrangement, timing, etc., of the operations or processes depicted in FIG. 17.

As shown, process 1700 can include determining an expected generation of a transport block (TB) to be transmitted in a slot of a sidelink (SL) channel (block 1710). Process 1700 can include monitoring a sensing window of the SL channel, based on the expected generation of the TB, the sensing window beginning and ending before the slot of the TB (block 1720). Process 1700 can include determining a selection window based on a transmission schedule associated with the TB (block 1730). Process 1700 can include selecting time and frequency resources in the selection window (block 1740). Process 1700 can include generating the TB for transmission on the selected time and frequency resources via a physical SL shared channel (PSSCH) (block 1750). These and many other features, examples, and examples can be combined in one or more ways as described herein.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, baseband circuitry can comprise: a memory; and one or more processors configured to, when executing instructions stored in the memory, cause the baseband circuitry to: determine an expected generation of a transport block (TB) to be transmitted in a slot of a sidelink (SL) channel; monitor a sensing window of the SL channel, based on the expected generation of the TB, the sensing window beginning and ending before the slot of the TB; determine a selection window based on a transmission schedule associated with the TB; select time and frequency resources in the selection window; and generate the TB for transmission on the selected time and frequency resources via a physical SL shared channel (PSSCH).

In example 2, which can also include one or more of the examples described herein, a beginning of the sensing window comprises a duration equal to a sensing time and a processing time measured in a time domain from the slot.

In example 3, which can also include one or more of the examples described herein, the sensing time comprises a duration involved in sensing the SL channel.

In example 4, which can also include one or more of the examples described herein, the processing time comprises a duration of time involved in processing the SL channel.

In example 5, which can also include one or more of the examples described herein, the expected generation of the TB is determined prior to the beginning of the sensing window.

In example 6, which can also include one or more of the examples described herein, the one or more processors are configured to cause the baseband circuitry to: determine potentially occupied time-frequency resources of a selection widow by decoding 1st-stage sidelink (SL) control information; and identify resources for transmission randomly from remaining available resources of the selection window.

In example 7, which can also include one or more of the examples described herein, the one or more processors are configured to cause the baseband circuitry to: determine potentially occupied time-frequency resources of a selection widow by decoding 1st-stage sidelink (SL) control information; and identify resources for transmission randomly from remaining available resources of the selection window.

In example 8, which can also include one or more of the examples described herein, when an expected time of arrival of the TB is split across more than one slot, with varying prediction confidence levels, an earliest candidate slot comprises slot n for determining a start of the sensing window.

In example 9, which can also include one or more of the examples described herein, resource reservation for possible re-transmission of the TB is configured to occur via multiple resource requests in a single 1st-stage SL control information (SCI) or multiple 1st-stage SCIs.

In example 10, which can also include one or more of the examples described herein, the one or more processors are configured to cause the baseband circuitry to: process a sensing window configuration and perform the channel sensing based on the sensing window configuration.

In example 11, which can also include one or more of the examples described herein, the sensing window configuration comprises at least one of a start time, a channel sensing duration, a periodicity of the channel sensing duration, or a combination thereof.

In example 12, which can also include one or more of the examples described herein, a sensing window configuration originates from a base station.

In example 13, which can also include one or more of the examples described herein, the one or more processors are configured to cause the baseband circuitry to: monitor the SL channel during a configured channel sensing duration for 1st-stage SCIs from other UEs to transmit data.

In example 14, which can also include one or more of the examples described herein, when a SL data transfer session is established with a peer UE, a receiving UE is configured to modify a channel sensing configuration based on one or more of the following information provided by the peer UE: data transmission periodicity, data transmission periodicity and jitter, prediction model parameters used by a transmitting UE to determine future TB arrivals, or prediction model identifier (ID) configured to for the transmitting UE.

In example 15, which can also include one or more of the examples described herein, a UE traffic prediction module is configured to receive an input comprising: UE orientation or pose input, UE heading information input, packet arrival time history input, in-band SL positioning measurement, out-of-band sensor input, or a combination thereof.

In example 16, which can also include one or more of the examples described herein, a UE traffic prediction module is configured to receive an input comprising: ultra-wideband (UWB) input, radar input, lidar input, camera input, accelerometer input, gyroscope input, or a combination thereof.

In example 17, which can also include one or more of the examples described herein, a UE traffic prediction module is configured to generate: an output comprises a next packet arrival time, a packet size, a TB size, a QoS of a next arriving packet, a priority of the next arriving packet, a confidence level, or a combination thereof.

In example 18, which can also include one or more of the examples described herein, a network configuration is received form a base station, the network configuration comprising: a sensing window start time (T₃) a selection window start and end time (T₁, T₂), a processing time (T_{proc}), prediction model information, prediction trigger conditions, a sensing window start time per QoS class (T′₃, T″₃) or a combination thereof.

In example 19, which can also include one or more of the examples described herein, the processing time is based on a UE category, or the processing time is based on a UE capability reported to the base station, or a combination thereof.

In example 20, which can also include one or more of the examples described herein, the one or more processors is configured to cause the baseband circuit to: reserve resources in advance of the TB arriving in a buffer; and include the resources in a 1st-stage SCI, wherein: a QoS or priority for a predicted transmission is included in a 1st-stage SCI, or a prediction confidence for the predicted transmission is included in the 1st-stage SCI.

In example 21, which can also include one or more of the examples described herein, the one or more processors is configured to cause the baseband circuit to: override a resource reservation for a predicted transmission when: a pending TB buffered is of a higher QoS is buffer, the pending TB buffered is of a buffer belonging to a same QoS and a prediction confidence contained in a previously received 1st-stage SCI is less than a threshold R₁, the pending TB buffered belongs to a lower QoS and a prediction confidence contained in a previously received 1st-stage SCI is less than a threshold R₂.

In example 22, which can also include one or more of the examples described herein, multiple prediction confidence thresholds correspond to different QoSs.

In example 23, which can also include one or more of the examples described herein, the one or more processors are configured to cause the baseband circuitry to: engage in channel monitoring or reception.

In example 24, which can also include one or more of the examples described herein, the one or more processors are configured to cause the baseband circuitry to: sense a channel for early resources for high-priority data transmission.

In example 25, which can also include one or more of the examples described herein, the one or more processors are configured to cause the baseband circuitry to: when at an end of the sensing window there are not enough available resources in the selection window to perform a data transmission, the baseband circuitry is configured to autonomously extend the sensing window by a pre-configured amount to increase a probability of finding sufficient resources for the data transmission.

In example 26, which can also include one or more of the examples described herein, the one or more processors are configured to cause the baseband circuitry to: autonomously extend the sensing window when the baseband circuitry determines that remaining resources in the selection window, after removing previously reserved resources and resources potentially utilized by other UEs, are configured to result in higher than acceptable probability of collision with potential transmissions from the other UEs after random selection.

In example 27, which can also include one or more of the examples described herein, the one or more processors are configured to cause the baseband circuitry to: monitor a smaller frequency range for higher priority data and monitor a larger frequency range for lower priority data, the smaller frequency range being a frequency range that is smaller than the larger frequency range.

In example 28, which can also include one or more of the examples described herein, the higher priority data comprises a higher QoS, and the lower priority data comprises a lower QoS.

In example 29, which can also include one or more of the examples described herein, one or more processors are configured to cause the baseband circuitry to: switch a sensing window duration and a selecting window direction when a channel occupancy predictor estimates that a channel occupancy is to be below a channel occupancy threshold; and revert back to a default window size when a channel occupancy predictor estimates a high channel occupancy for a TB transmission, a TB transmission using smaller windows results in collision, no transmission resources are available after elimination for potential occupancy based on sensing, or a combination thereof.

In example 30, which can also include one or more of the examples described herein, the one or more processors are configured to cause the baseband circuitry to: bias a choice of transmission resources from a candidate resource within a selection window according to a priority of a pending TB or estimated channel occupancy.

In example 31, which can also include one or more of the examples described herein, the one or more processors are configured to cause the baseband circuitry to: deploy an artificial intelligence (AI)/machine learning (ML) model to predict idle periods during which continuous channel sensing is to be temporarily paused for a duration of. each idle period.

In example 32, which can also include one or more of the examples described herein, the one or more processors are configured to cause the baseband circuitry to: switch between different modes of sensing in response to one or more conditions or thresholds, the different modes of sensing comprising: continuous channel sensing comprising ongoing channel sensing; continuous channel sensing with idle period; and need-based channel sensing.

In example 33, which can also include one or more of the examples described herein, a method can comprise: predicting an arrival of a transport block (TB) in a slot of a physical sidelink (SL) control channel (PSCCH); monitoring a sensing window of the PSCCH, based on the predicted arrival of the TB, the sensing window beginning and ending before the slot of the TB; determining a selection window based on a transmission schedule associated with the TB; identifying time and frequency resources of the selection window; and generating, based on the time and frequency resources of the selection window, a SL communication for transmitting the TB via a physical SL shared channel (PSSCH).

In example 34, which can also include one or more of the examples described herein, a non-transitory, computer-readable medium can comprise: instructions that when expected by one or more processors cause the one or more processors to: determine an expected generation of a transport block (TB) to be transmitted in a slot of a sidelink (SL) channel; monitor a sensing window of the SL channel, based on the expected generation of the TB, the sensing window beginning and ending before the slot of the TB; determine a selection window based on a transmission schedule associated with the TB; select time and frequency resources in the selection window; and generate the TB for transmission on the selected time and frequency resources via a physical SL shared channel (PSSCH).

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. Baseband circuitry, comprising:
a memory; and
one or more processors configured to, when executing instructions stored in the memory, cause the baseband circuitry to:
determine an expected generation of a transport block (TB) to be transmitted in a slot of a sidelink (SL) channel;
monitor a sensing window of the SL channel, based on the expected generation of the TB, the sensing window beginning and ending before the slot of the TB;
determine a selection window based on a transmission schedule associated with the TB select time and frequency resources in the selection window; and
generate the TB for transmission on the selected time and frequency resources via a physical SL shared channel (PSSCH).

2. The baseband circuitry of claim 1, wherein a beginning of the sensing window comprises a duration equal to a sensing time and a processing time measured in a time domain from the slot.

3. The baseband circuitry of claim 2, wherein the sensing time comprises a duration involved in sensing the SL channel.

4. The baseband circuitry of claim 3, wherein:
the processing time comprises a duration of time involved in processing the SL channel.

5. The baseband circuitry of claim 3, wherein the expected generation of the TB is determined prior to the beginning of the sensing window.

6. The baseband circuitry of claim 1, wherein the one or more processors are configured to cause the baseband circuitry to:
determine potentially occupied time-frequency resources of a selection widow by decoding 1st-stage sidelink (SL) control information; and
identify resources for transmission randomly from remaining available resources of the selection window.

7. The baseband circuitry of claim 1, wherein, when an expected time of arrival of the TB is split across more than one slot, with varying prediction confidence levels, an earliest candidate slot comprises slot n for determining a start of the sensing window.

8. The baseband circuitry of claim 1, wherein resource reservation for possible re-transmission of the TB is configured to occur via multiple resource requests in a single 1st-stage SL control information (SCI) or multiple 1st-stage SCIs.

9. The baseband circuitry of claim 1, wherein the one or more processors are configured to cause the baseband circuitry to:
monitor the SL channel during a configured channel sensing duration for 1st-stage SCI from other user equipment (UEs) to transmit data.

10. The baseband circuitry of claim 1, wherein a UE traffic prediction module is configured to receive an input comprising:
UE orientation or pose input,
UE heading information input,
packet arrival time history input,
in-band SL positioning measurement,
out-of-band sensor input,
ultra-wideband (UWB) input,
radar input,
lidar input,
camera input,
accelerometer input,
gyroscope input, or
a combination thereof.

11. The baseband circuitry of claim 1, wherein a UE traffic prediction module is configured to generate:
an output comprises a next packet arrival time,
a packet size,
a TB size,
a QoS of a next arriving packet,
a priority of the next arriving packet,
a confidence level, or
a combination thereof.

12. The baseband circuitry of claim 1, wherein a network configuration is received form a base station, the network configuration comprising:
a sensing window start time (T₃)
a selection window start and end time (T₁, T₂),
a processing time (T_{proc}),
prediction model information,
prediction trigger conditions,
a sensing window start time per QoS class (T′₃, T″₃) or
a combination thereof.

13. The baseband circuitry of claim 1, wherein the one or more processors is configured to cause the baseband circuitry to:
reserve resources in advance of the TB arriving in a buffer; and
include the resources in a 1st-stage SCI, wherein:
a QoS or priority for a predicted transmission is included in a 1st-stage SCI, or
a prediction confidence for the predicted transmission is included in the 1st-stage SCI.

14. The baseband circuitry of claim 1, wherein the one or more processors is configured to cause the baseband circuitry to:
override a resource reservation for a predicted transmission when:
a pending TB buffered is of a higher QoS is buffer,
the pending TB buffered is of a buffer belonging to a same QoS and a prediction confidence contained in a previously received 1st-stage SCI is less than a threshold R₁,
the pending TB buffered belongs to a lower QoS and a prediction confidence contained in a previously received 1st-stage SCI is less than a threshold R₂.

15. The baseband circuitry of claim 1, wherein the one or more processors are configured to cause the baseband circuitry to:
sense a channel for early resources for high-priority data transmission.

16. The baseband circuitry of claim 1, wherein the one or more processors are configured to cause the baseband circuitry to:
when at an end of the sensing window there are not enough available resources in the selection window to perform a data transmission, the baseband circuitry is configured to autonomously extend the sensing window by a pre-configured amount to increase a probability of finding sufficient resources for the data transmission.

17. The baseband circuitry of claim 1, wherein the one or more processors are configured to cause the baseband circuitry to:
monitor a smaller frequency range for higher priority data, and
monitor a larger frequency range for lower priority data, the smaller frequency range being a frequency range that is smaller than the larger frequency range.

18. The baseband circuitry of claim 1, wherein the one or more processors are configured to cause the baseband circuitry to:
switch a sensing window duration and a selecting window direction when a channel occupancy predictor estimates that a channel occupancy is to be below a channel occupancy threshold; and
revert back to a default window size when a channel occupancy predictor estimates a high channel occupancy for a TB transmission, a TB transmission using smaller windows results in collision, no transmission resources are available after elimination for potential occupancy based on sensing, or a combination thereof.

19. A method, comprising:
determining an expected generation of a transport block (TB) to be transmitted in a slot of a sidelink (SL) channel;
monitoring a sensing window of the SL channel, based on the expected generation of the TB, the sensing window beginning and ending before the slot of the TB;
determining a selection window based on a transmission schedule associated with the TB selecting time and frequency resources in the selection window; and
generating the TB for transmission on the selected time and frequency resources via a physical SL shared channel (PSSCH).

20. A non-transitory, computer-readable medium, comprising:
instructions that when expected by one or more processors cause the one or more processors to:
determine an expected generation of a transport block (TB) to be transmitted in a slot of a sidelink (SL) channel;
monitor a sensing window of the SL channel, based on the expected generation of the TB, the sensing window beginning and ending before the slot of the TB;
determine a selection window based on a transmission schedule associated with the TB select time and frequency resources in the selection window; and
generate the TB for transmission on the selected time and frequency resources via a physical SL shared channel (PSSCH).
